(19) United States
(12) Patent Application Publication
(10) Pub. No.: US 2008/0095551 A1
(43) Pub. Date: Apr. 24, 2008

(54) Image Generating Apparatus

(75) Inventor: Norito Tsujimoto, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/876,819

(22) Filed: Oct. 23, 2007

(30) Foreign Application Priority Data
Oct. 23, 2006 (JP) 2006-287891

(51) Int. Cl. G03G 15/00

(52) U.S. Cl. 399/89; 399/136

(57) ABSTRACT

Obtained is an image generating apparatus capable of suppressing power consumption in the overall apparatus in printing. This image generating apparatus includes a driving source for driving transport means transporting a paper printable with image data and a control portion supplying a first amount of energy to the driving source in an acceleration period of the driving source for bringing the paper to a constant speed from the start of transportation while switching to a second amount of energy smaller than the first amount of energy in synchronization with arrival of the paper at the constant speed for supplying the second amount of energy to the driving source.

### BACKGROUND OF THE INVENTION

1. Field of the Invention

The present invention relates to an image generating apparatus, and more particularly, it relates to an image generating apparatus comprising a driving source for driving transport means transporting papers printable with image data.

2. Description of the Background Art

An image generating apparatus comprising a driving source for driving transport means transporting papers printable with image data and an image reader comprising a driving source for driving scanning means reciprocating a scanning portion (scanner or the like) for image data are known in general, as disclosed in Japanese Patent Laying-Open Nos. 2005-227416, 2005-92062 and 2000-196823, for example.

The aforementioned Japanese Patent Laying-Open No. 2005-227416 discloses an image generating apparatus (digital complex machine) comprising an image reader constituted of scanning means loaded with a scanner reading image data from an original and photoelectrically converting the same to an image signal and capable of reciprocating the scanner on the original and a pulse motor (stepping motor) functioning as a driving source for reciprocation of the scanning means. This image generating apparatus (digital complex machine) is so formed as to drive/control the pulse motor for bringing the scanning means to a reading speed (constant speed) with initial acceleration and second acceleration smaller than the initial acceleration in accelerative driving before the scanner reaches the reading speed.

The aforementioned Japanese Patent Laying-Open No. 2005-92062 discloses an image generating apparatus (radiation image recording/reading apparatus) comprising a reading/erasing unit capable of reading radiation energy recorded in a storage-type phosphor sheet as image information by reciprocating on the storage-type phosphor sheet and removing the radiation energy remaining after the reading and a pulse motor (stepping motor) functioning as a driving source for the reciprocation of the reading/erasing unit. This image generating apparatus (radiation image recording/reading apparatus) is so formed as to supply a driving current responsive to a pulse speed necessary for the pulse motor to the pulse motor after deciding the erasing time and the erasing speed (scanning speed) of the reading/erasing in response to the residue of the radiation energy when removing the radiation energy.

The aforementioned Japanese Patent Laying-Open No. 2000-196823 discloses an image reader (digital copying machine) comprising a carriage (original scanning portion) loaded with a line sensor reading image data from an original and photoelectrically converting the same to an image signal and capable of reciprocating the line sensor on the original and a stepping motor functioning as a driving source for the reciprocation of the carriage (original scanning portion). This image reader (digital copying machine) is so formed as to drive/control the stepping motor with two types of currents including a current for accelerative driving and another current for constant-speed driving set lower than the current for accelerative driving. The image reader (digital copying machine) is also so formed as to supply the current for accelerative driving in a prescribed period of constant-speed driving, and to switch to a current for constant-speed driving after a lapse of the prescribed period.

However, the aforementioned Japanese Patent Laying-Open No. 2005-227416 neither discloses nor suggests a method of controlling the pulse motor by changing the value of a driving current, for example, in a reading operation at the constant speed after the scanning means reaches the constant speed, although the image generating apparatus (digital complex machine) controls the driving current for the pulse motor in two stages in the accelerative driving for bringing the scanning means to the constant speed. Therefore, the driving current at the constant speed may conceivably be supplied to the apparatus at a value exceeding driving torque required by the pulse motor for moving the scanning means. When the method of controlling the pulse motor according to Japanese Patent Laying-Open No. 2005-227416 is applied to an image generating apparatus (sublimatic printer, for example) printing papers through heat generated by a print head, power consumption in the overall apparatus is disadvantageously increased in printing due to excessive power supplied to the pulse motor transporting the papers at the constant speed in addition to power consumed by the print head generating heat for printing.

The aforementioned Japanese Patent Laying-Open No. 2005-92062 neither discloses nor suggests a method of controlling the pulse motor by changing the value of the driving current, for example, in an erasing operation at the constant speed after the reading/erasing unit reaches the constant speed, although the image generating apparatus (radiation image recording/reading apparatus) controls the driving current for the pulse motor in response to the pulse speed as to accelerative driving for bringing the reading/erasing unit to the constant speed. Therefore, the driving current at the constant speed may conceivably be supplied to the apparatus at a value exceeding driving torque required by the pulse motor for moving the reading/erasing unit. When the method of controlling the pulse motor according to Japanese Patent Laying-Open No. 2005-92062 is applied to an image generating apparatus (sublimatic printer, for example) printing papers through heat generated by a print head, power consumption in the overall apparatus is disadvantageously increased in printing due to excessive power supplied to the pulse motor transporting the papers at the constant speed in addition to power consumed by the print head generating heat for printing.

In the image reader (digital copying machine) proposed in the aforementioned Japanese Patent Laying-Open No. 2000-196823, the driving current in acceleration is not reduced but continuously supplied to the stepping motor for the prescribed period after the carriage (original scanning portion) is accelerated to reach the constant speed, whereby the driving current at the constant speed may conceivably be supplied to the apparatus at a value exceeding driving torque required by the stepping motor for moving the carriage (original scanning portion). When the method of controlling the stepping motor according to Japanese Patent Laying-Open No. 2000-196823 is applied to an image generating apparatus (sublimatic printer, for example) printing papers through heat generated by a print head, power consumption in the overall apparatus is disadvantageously increased in printing due to excessive power supplied to the stepping motor transporting the papers at the constant speed in addition to power consumed by the print head generating heat for printing.

### SUMMARY OF THE INVENTION

The present invention has been proposed in order to solve the aforementioned problems, and an object of the present invention is to provide an image generating apparatus capable of suppressing power consumption in the overall apparatus in printing.

An image generating apparatus according to a first aspect of the present invention comprises a driving source for driving transport means transporting a paper printable with image data and a control portion supplying a first amount of energy to the driving source in an acceleration period of the driving source for bringing the paper to a constant speed from the start of transportation while switching to a second amount of energy smaller than the first amount of energy in synchronization with arrival of the paper at the constant speed for supplying the second amount of energy to the driving source.

As hereinabove described, the image generating apparatus according to the first aspect of the present invention is so formed as to comprise the control portion supplying the first amount of energy to the driving source in the acceleration period of the driving source for bringing the paper to the constant speed from the start of transportation while switching to the second amount of energy smaller than the first amount of energy in synchronization with arrival of the paper at the constant speed for supplying the second amount of energy to the driving source for making control of reducing the amount of energy supplied to the driving source transporting the paper at the constant speed from the first amount of energy to the second amount of energy smaller than the fist amount of energy in synchronization with the time for starting printing when the paper reaches the constant speed and a print head generates heat to consume power, whereby power consumption in the overall apparatus can be reduced in printing dissimilarly to a case of making control of not changing the amount of energy supplied to the driving source in the acceleration period of the driving source in the start of paper transportation and the amount of energy supplied to the driving source for driving the same at the constant speed in printing or making control of not reducing the amount of energy in the prescribed period in printing after a lapse of the acceleration period.

In the aforementioned image generating apparatus according to the first aspect, the first amount of energy supplied to the driving source in the acceleration period of the driving source is preferably substantially the maximum amount of energy in the drivable range of the driving source. According to this structure, the driving source can start transporting the paper with the maximum acceleration, whereby the acceleration period for bringing the paper to the constant speed can be minimized. Therefore, the total printing time including the time for paper transportation can be further reduced.

In the aforementioned image generating apparatus according to the first aspect, the amount of energy supplied to the driving source at the constant speed is preferably not more than ⅔ of the maximum amount of energy supplied to the driving source in the acceleration period. According to this structure, power consumption in the driving source can be effectively reduced by setting the amount of energy to a level of not more than ⅔ attaining driving torque allowing transportation of the paper at the constant speed in printing.

The aforementioned image generating apparatus according to the first aspect preferably further comprises a storage portion storing an acceleration table defining a rotational speed with respect to a driving time of the driving source, and the control portion preferably drives the driving source on the basis of the acceleration table in the acceleration period of the driving source. According to this structure, the control portion can make control of smoothly transporting the paper when the driving source starts acceleration (starts transporting the paper) and when the driving source ends the acceleration (upon arrival of the paper at a prescribed transport speed) respectively, thereby transporting the paper in the optimum state without steeply changing the transport speed for the paper.

In this case, the storage portion preferably stores a plurality of acceleration tables in response to the printing quality of the image data. According to this structure, the control portion can easily transport the paper at a speed responsive to the printing quality of the image data by selecting the optimum acceleration table.

In the aforementioned image generating apparatus according to the first aspect, the paper preferably includes a printed portion printed with the image data and a margin not printed with the image data, and the control portion preferably makes control as the acceleration period of the driving source at least when transporting the margin of the paper. According to this structure, the transport speed for the paper can be increased through the margin not directly relevant to printing, whereby the total printing time including the time for paper transportation can be further reduced.

In the aforementioned image generating apparatus according to the first aspect, the control portion preferably makes the control as the acceleration period of the driving source not only when transporting the margin of the paper but also when transporting a position of the printed portion printed with the image data. According to this structure, the transport speed for the paper can be increased also when the paper is transported to a printing start position, whereby the transport time for the paper can be further reduced.

The aforementioned image generating apparatus according to the first aspect preferably further comprises an apparatus body detachably mounted with a paper feed cassette storing the paper, and the control portion preferably makes control as the acceleration period of the driving source when transporting the paper from the paper feed cassette to the apparatus body. According to this structure, the transport speed for the paper can be increased also when the paper is transported from the paper feed cassette to the apparatus body, whereby the transport time for the paper can be further reduced.

In the aforementioned image generating apparatus according to the first aspect, the driving source is preferably a stepping motor whose rotation angle is controllable with a pulse number. According to this structure, the rotational speed of the driving source can be controlled by controlling the pulse number, whereby the transport speed for the paper including that in the acceleration period can be reliably controlled and the amount of energy supplied to the driving source can be switched at reliable timing after the arrival at the constant speed.

In the aforementioned image generating apparatus according to the first aspect, both of the first amount of energy and the second amount of energy supplied to the driving source are preferably currents. According to this structure, a control circuit for carrying out a constant voltage control system controlling currents supplied to the driving source can be more easily designed on an electric circuit as compared with a case of designing a control circuit for carrying out a constant current control system controlling voltages supplied to the driving source.

In the aforementioned image generating apparatus according to the first aspect, both of the first amount of energy and the second amount of energy supplied to the driving source are preferably voltages. According to this structure, the control portion can control the driving source also in the constant current control system controlling voltages supplied to the driving source similarly to the above, whereby power consumption in the overall apparatus can be reduced in printing.

An image generating apparatus according to a second aspect of the present invention comprises a driving source for driving transport means transporting a paper printable with image data and a control portion transporting at least a margin of the paper and supplying a first amount of energy substantially corresponding to the maximum amount of energy in the drivable range of the driving source to the driving source in an acceleration period of the driving source for bringing the paper to a constant speed from the start of transportation while switching to a second amount of energy, smaller than the first amount of energy, not more than ⅔ of the first amount of energy in synchronization with arrival of the paper at the constant speed for supplying the second amount of energy to the driving source, the paper includes a printed portion printed with the image data and the margin not printed with the image data, and the driving source is a stepping motor whose rotation angle is controllable with a pulse number.

As hereinabove described, the image generating apparatus according to the second aspect of the present invention is so formed as to comprise the control portion supplying the first amount of energy to the driving source in the acceleration period of the driving source for bringing the paper to the constant speed from the start of transportation while switching to the second amount of energy smaller than the first amount of energy in synchronization with arrival of the paper at the constant speed for supplying the second amount of energy to the driving source for making control of reducing the amount of energy supplied to the driving source transporting the paper at the constant speed from the first amount of energy to the second amount of energy smaller than the fist amount of energy in synchronization with the time for starting printing when the paper reaches the constant speed and a print head generates heat to consume power, whereby power consumption in the overall apparatus in can be reduced in printing dissimilarly to a case of making control of not changing the amount of energy supplied to the driving source in the acceleration period of the driving source in the start of paper transportation and the amount of energy supplied to the driving source for driving the same at the constant speed in printing or making control of not reducing the amount of energy in the prescribed period in printing after a lapse of the acceleration period.

In the image generating apparatus according to the second aspect, further, the first amount of energy supplied to the driving source in the acceleration period of the driving source is substantially the maximum amount of energy in the drivable range of the driving source so that the driving source can start transporting the paper with the maximum acceleration, whereby the acceleration period for bringing the paper to the constant speed can be minimized. Therefore, the total printing time including the time for paper transportation can be further reduced. In addition, the amount of energy supplied to the driving source at the constant speed is not more than ⅔ of the maximum amount of energy supplied to the driving source in the acceleration period, whereby power consumption in the driving source can be effectively reduced by setting the amount of energy to a level of not more than ⅔ attaining driving torque allowing transportation of the paper at the constant speed in printing. Further, the paper includes the printed portion printed with the image data and the margin not printed with the image data while the control portion makes the control as the acceleration period of the driving source at least when transporting the margin of the paper so that the transport speed for the paper can be increased through the margin not directly relevant to printing, whereby the total printing time including the time for paper transportation can be further reduced. Further, the driving source is formed by the stepping motor whose rotation angle is controllable with a pulse number so that the rotational speed of the driving source can be controlled by controlling the pulse number, whereby the transport speed for the paper including that in the acceleration period can be reliably controlled and the amount of energy supplied to the driving source can be switched at reliable timing after the arrival at the constant speed.

The aforementioned image generating apparatus according to the second aspect preferably further comprises a storage portion storing an acceleration table defining a rotational speed with respect to a driving time of the driving source, and the control portion preferably drives the driving source on the basis of the acceleration table in the acceleration period of the driving source. According to this structure, the control portion can make control of smoothly transporting the paper when the driving source starts acceleration (starts transporting the paper) and when the driving source ends the acceleration (upon arrival of the paper at a prescribed transport speed) respectively, thereby transporting the paper in the optimum state without steeply changing the transport speed for the paper.

In this case, the storage portion preferably stores a plurality of acceleration tables in response to the printing quality of the image data. According to this structure, the control portion can easily transport the paper at a speed responsive to the printing quality of the image data by selecting the optimum acceleration table.

In the aforementioned image generating apparatus according to the second aspect, the control portion preferably makes the control as the acceleration period of the driving source not only when transporting the margin of the paper but also when transporting a position of the printed portion printed with the image data. According to this structure, the transport speed for the paper can be increased also when the paper is transported to a printing start position, whereby the transport time for the paper can be further reduced.

The aforementioned image generating apparatus according to the second aspect preferably further comprises an apparatus body detachably mounted with a paper feed cassette storing the paper, and the control portion preferably makes control as the acceleration period of the driving source when transporting the paper from the paper feed cassette to the apparatus body. According to this structure, the transport speed for the paper can be increased through the margin not directly relevant to printing, whereby the total printing time including the time for paper transportation can be further reduced.

In the aforementioned image generating apparatus according to the second aspect, both of the first amount of energy and the second amount of energy supplied to the driving source are preferably currents. According to this structure, a control circuit for carrying out a constant voltage control system controlling currents supplied to the driving source can be more easily designed on an electric circuit as compared with a case of designing a control circuit for carrying out a constant current control system controlling voltages supplied to the driving source.

In the aforementioned image generating apparatus according to the second aspect, both of the first amount of energy and the second amount of energy supplied to the driving source are preferably voltages. According to this structure, the control portion can control the driving source also in the constant current control system controlling voltages supplied to the driving source similarly to the above, whereby power consumption in the overall apparatus can be reduced in printing.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing the overall structure of a sublimatic printer according to an embodiment of the present invention;

FIG. 2 is a perspective view illustrating the sublimatic printer according to the embodiment of the present invention shown in FIG. 1, while omitting an ink sheet cartridge and a paper feed cassette;

FIG. 3 is a block diagram showing the circuit structure of the sublimatic printer according to the embodiment of the present invention shown in FIG. 1;

FIG. 4 is a perspective view of the sublimatic printer according to the embodiment of the present invention shown in FIG. 1;

FIG. 5 is a sectional view for illustrating the internal structure of the sublimatic printer according to the embodiment of the present invention shown in FIG. 1;

FIG. 6 is a side elevational view showing arrangement of stepping motors and gears of the sublimatic printer according to the embodiment of the present invention shown in FIG. 1;

FIG. 7 is a plan view of the sublimatic printer according to the embodiment of the present invention shown in FIG. 1;

FIG. 8 detailedly illustrates a print head of the sublimatic printer according to the embodiment of the present invention shown in FIG. 1;

FIG. 9 is a diagram for illustrating a paper employed in the sublimatic printer according to the embodiment of the present invention shown in FIG. 1;

FIG. 10 illustrates an exemplary acceleration table of the sublimatic printer according to the embodiment of the present invention shown in FIG. 1;

FIG. 11 is a diagram for illustrating the pulse speed of one of the stepping motors following the acceleration table of the sublimatic printer according to the embodiment of the present invention shown in FIG. 1;

FIG. 12 is a diagram for illustrating control of the value of a current supplied to the stepping motor in paper transportation of the sublimatic printer according to the embodiment of the present invention shown in FIG. 1;

FIGS. 13 and 14 are diagrams for illustrating a printing operation of the sublimatic printer according to the embodiment of the present invention shown in FIG. 1;

FIG. 15 is a flow chart for illustrating a control operation in printing of the sublimatic printer according to the embodiment of the present invention shown in FIG. 1; and

FIG. 16 is a flow chart for illustrating an operation of controlling the stepping motor in paper transportation of the sublimatic printer according to the embodiment of the present invention shown in FIG. 1.

### DESCRIPTION OF THE PREFERRED EMBODIMENTS

An embodiment of the present invention is now described with reference to the drawings.

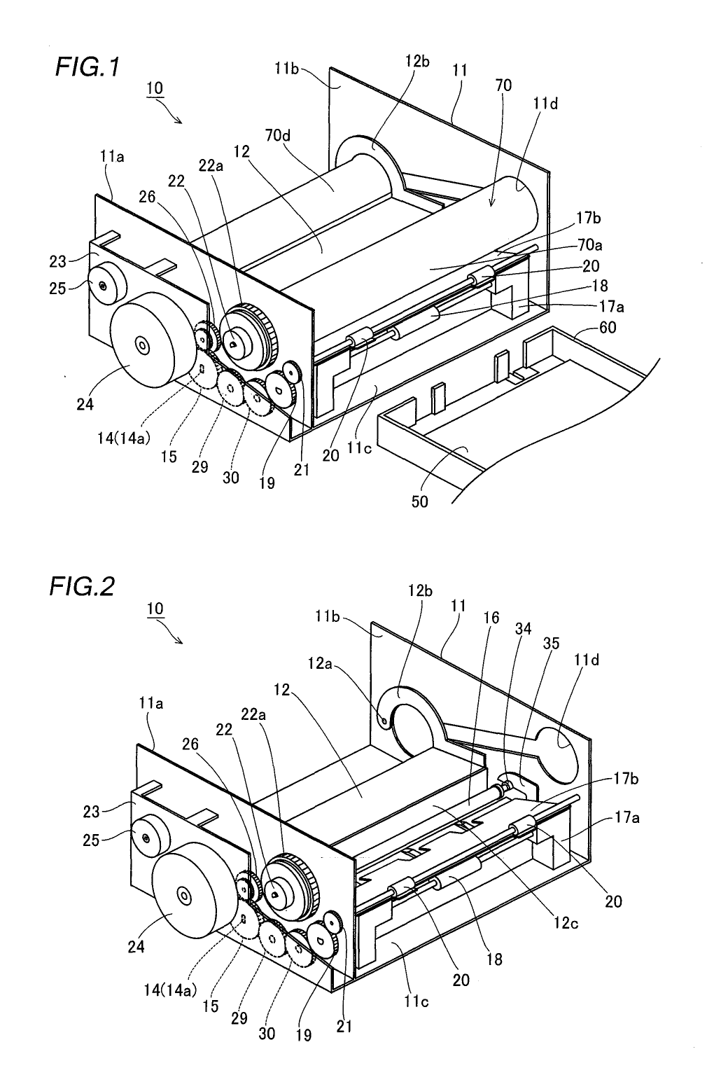

The structure of a sublimatic printer 10 according to the embodiment of the present is described with reference to FIGS. 1 to 12. This embodiment of the present invention is applied to the sublimatic printer 10 employed as an exemplary image generating apparatus.

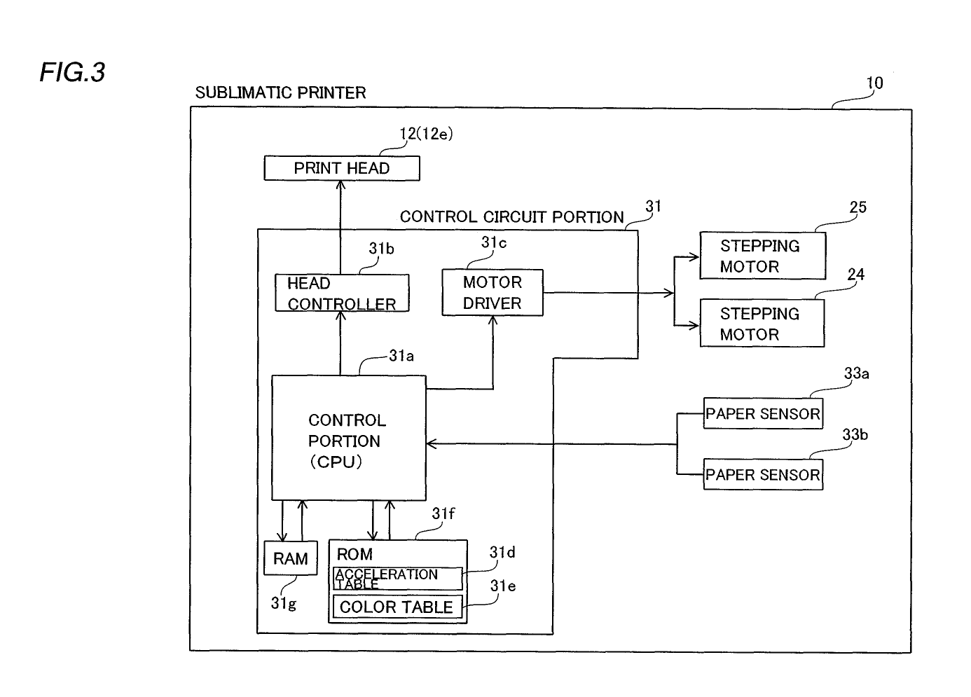

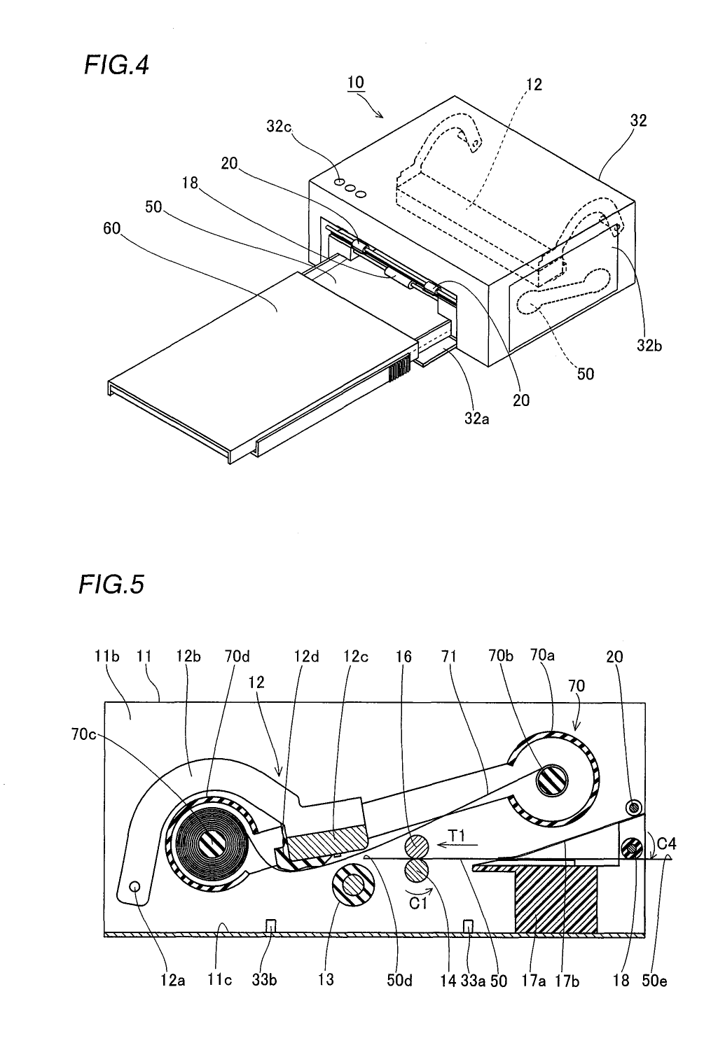

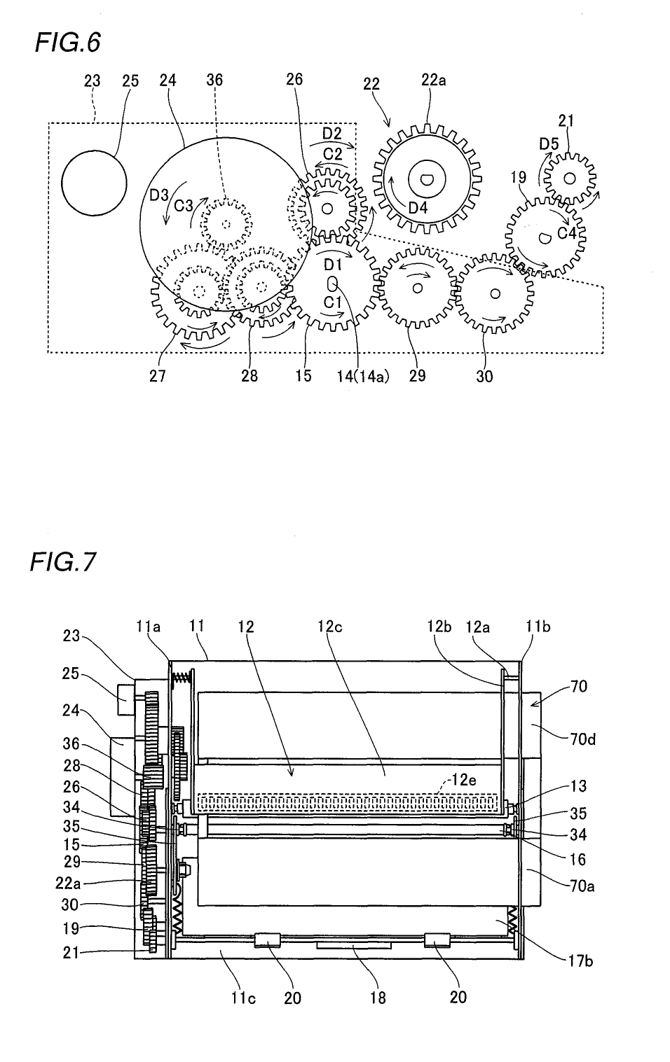

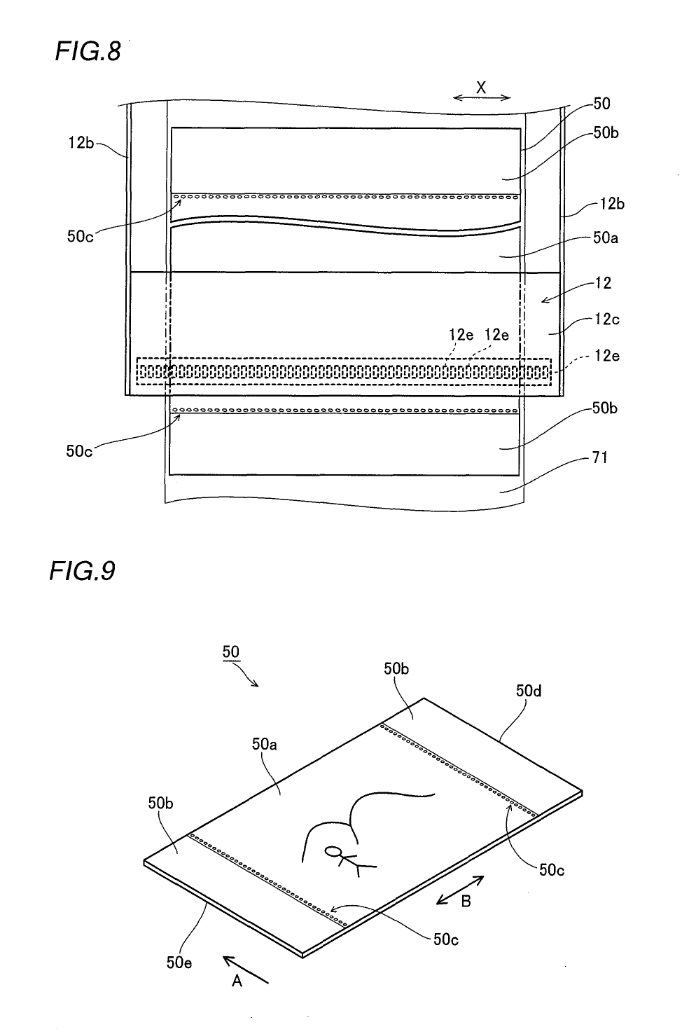

As shown in FIGS. 1 and 2, the sublimatic printer 10 according to the embodiment of the present invention comprises a chassis 11 of metal, a print head 12 for printing, a platen roller 13 (see FIG. 5) opposed to the print head 12, a feed roller 14 (see FIG. 5) of metal, a feed roller gear 15, a press roller 16 (see FIG. 5) of metal coming into contact with the feed roller 14 (see FIG. 5) with prescribed pressing force, a lower paper guide 17a of resin, an upper paper guide 17b of resin, a paper feed roller 18 of rubber, a paper feed roller gear 19, a paper discharge roller 20 of rubber, a paper discharge roller gear 21, an ink sheet take-up reel 22, a motor bracket 23 of sheet metal, a stepping motor 24 for transporting each paper 50 (see FIG. 1), another stepping motor 25 serving as a driving source for rotating the print head 12, a swingable swing gear 26, a plurality of intermediate gears 27 to 30 (see FIG. 6), a control circuit portion 31 (see FIG. 3) controlling a printing operation of the sublimatic printer 10 and a housing 32 (see FIG. 4) storing the chassis 11. An ink sheet cartridge 70 (see FIG. 1) storing an ink sheet 71 (see FIG. 8) capable of printing 20 papers 50 and a paper feed cassette 60 (see FIG. 1) for storing the papers 50 (see FIG. 1) fed to the sublimatic printer 10 are detachably mounted on the sublimatic printer 10 according to this embodiment. The feed roller 14 and the press roller 16 are examples of the “transport means” in the present invention respectively. The stepping motor 24 is an example of the “driving source” in the present invention.

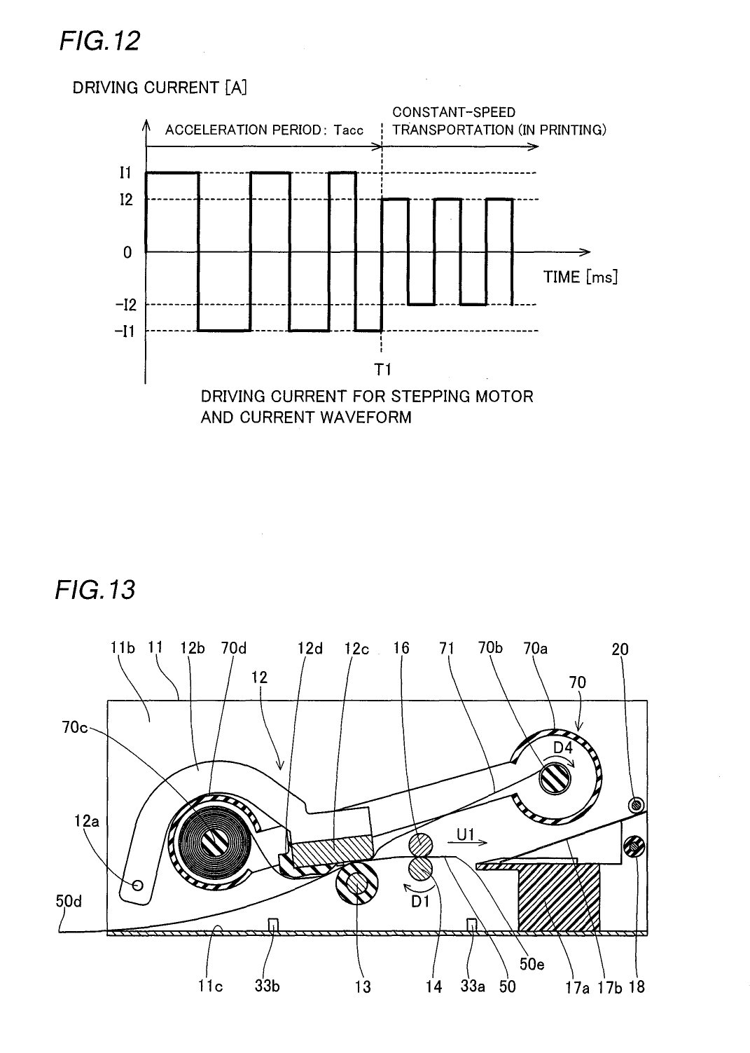

According to this embodiment, the control circuit portion 31 of the sublimatic printer 10 has a control portion 31a consisting of a CPU controlling the printing operation. The control portion 31a is so formed as to drive the stepping motor 24 in the start of printing and to increase the pulse speed (rotational speed) of the stepping motor 24 (see FIG. 3) until the transport speed for the papers 50 (see FIG. 5) reaches a predetermined printing speed Vp, as shown in FIG. 11. The control portion 31a is also so formed as to switch the current supplied to the stepping motor 24 (see FIG. 3) from a current I1 supplied in an acceleration period Tacc from the start of driving of the stepping motor 24 (see FIG. 3) up to arrival at the printing speed Vp (pulse speed) to a current I2 supplied to the stepping motor 24 after the arrival at the printing speed Vp (according to this embodiment, the current I2 is set to ⅔ of the current I1), as shown in FIG. 12. The control portion 31a is further so formed as to supply the current I1 in the acceleration period Tacc substantially at the maximum level in the drivable range of the stepping motor 24 (see FIG. 3). In this case, the stepping motor 24 can reach the printing speed Vp at a time T1 along a velocity curve shown by a solid line 200 in FIG. 11. The control portion 31a is further so formed as to switch the current I1 (see FIG. 12) to the current I2 (see FIG. 12) at the time T1 (see FIGS. 11 and 12) synchronous with the arrival of the pulse speed of the stepping motor 24 (see FIG. 3) at the printing speed Vp (see FIG. 11). Further, the control portion 31a is so formed as to set the current I2 supplied at the printing speed Vp (see FIG. 11) lower than the current I1 supplied in the acceleration Tacc, as shown in FIG. 12. The printing speed Vp is an example of the “constant speed” in the present invention. The currents I1 and 12 are examples of the “first amount of energy” and the “second amount of energy” in the present invention respectively.

If the current supplied from the start of driving of the stepping motor 24 up to the arrival at the printing speed Vp is set equal to the current I2 supplied after the arrival at the printing speed Vp as comparative example, it follows that the stepping motor 24 reaches the printing speed Vp at a time T2 later than the time T1 along a velocity curve shown by a two-dot chain line 300 in FIG. 11. According to this embodiment, therefore, the time required for printing can be reduced by the difference (T2-T1) between the times T2 and T1 as compared with comparative example.

As shown in FIG. 3, the control circuit portion 31 further includes a head controller 31b controlling the temperature of heating elements 12e of the print head 12 on the basis of the control of the control portion 31a, a motor driver 31c driving the stepping motors 24 and 25 by supplying currents, a ROM (read only memory) 31f storing an acceleration table 31d and a color table 31e and a RAM (random access memory) 31g. The head controller 31b has a function of controlling the temperature of the heating elements 12e of the print head 12 by applying a voltage pulse thereto.

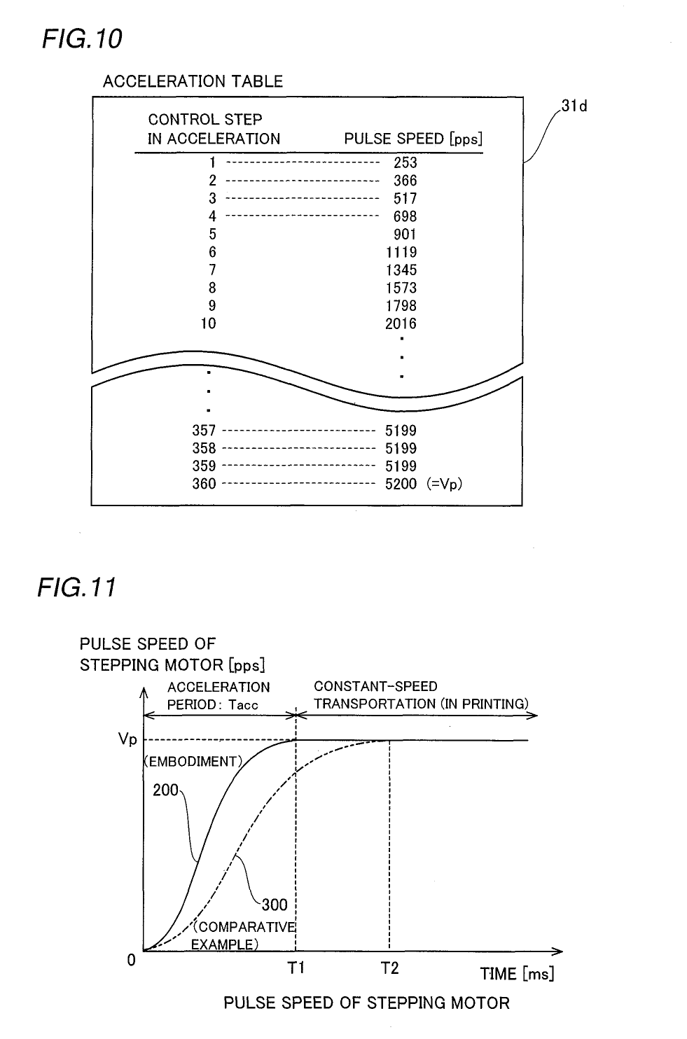

According to this embodiment, the acceleration table 31d has an acceleration pattern (velocity curve) defining a plurality of control steps (driving times for the stepping motor 24) for increasing the pulse speed of the stepping motor 24 (see FIG. 3) and pulse speeds (rotational speeds of the stepping motor 24) corresponding to the control steps respectively, as shown in FIG. 10. The control portion 31a (see FIG. 3) is so formed as to drive the stepping motor 24 (see FIG. 3) through the motor driver 31c (see FIG. 3) according to a selected acceleration pattern of the acceleration table 31d. Thus, the control portion 31a is enabled to smoothly bring the stepping motor 24 to the printing speed Vp at the time T1 while accelerating each paper 50 along the velocity curve shown by the solid line 200 in FIG. 11. The ROM 31f (see FIG. 3), storing only one acceleration table 31d in FIG. 10 for convenience of illustration, stores a plurality of such acceleration tables 31d in practice. Thus, the control portion 31a is enabled to select the optimum acceleration table 31d in response to the printing quality (a high definition printing mode or a standard printing mode) of image data.

As shown in FIG. 3, the RAM 31g has a region for expanding the acceleration table 31d for controlling rotation of the stepping motor 24, as well as a region for expanding the color table 31e defining temperature data (values of applied energy) necessary for the heating elements 12e of the print head 12 in printing.

According to this embodiment, each paper 50 has a thickness of about 0.3 mm, and includes a printed portion 50a and margins 50b, as shown in FIGS. 8 and 9. The margins 50b provided on both ends of the paper 50 have a prescribed width in the paper transport direction (along arrow B in FIG. 9). A plurality of perforations 50c are formed along the boundaries between the printed portion 50a and the margins 50b of the paper 50 along arrow A (see FIG. 9) at a prescribed pitch interval. The paper 50 is so formed that a print (printed portion 50a) having no margins 50b is obtained by cutting off the margins 50b along the perforations 50c. As hereinabove described, the control portion 31a (see FIG. 3) is so formed as to acceleratively drive the stepping motor 24 by supplying the current I1 (see FIG. 12) when transporting the margins 50b (see FIG. 9) of the paper 50 in the start of printing, thereafter switch to the current I2 (see FIG. 12) smaller than the current I1 (see FIG. 12) and transport the paper 50 at the printing speed Vp (see FIG. 11) by supplying the current I2 (see FIG. 12) to the stepping motor 24.

As shown in FIGS. 1 and 2, the chassis 11 of metal has a first side surface 11a, a second side surface 11b and a bottom surface 11c coupling the first and second side surfaces 11a and 11b with each other. The aforementioned motor bracket 23 of sheet metal is mounted on the first side surface 11a of the chassis 11. A receiving hole lid for receiving the ink sheet cartridge 70 is provided on the second side surface 11b of the chassis 11, as shown in FIGS. 1 and 2. Paper sensors 33a and 33b (see FIG. 5) for detecting front and rear ends 50d and 50e (see FIG. 5) of each paper 50 are provided on the bottom surface 11c of the chassis 1.

The print head 12 includes a pair of support shafts 12a, a pair of arm portions 12b, a head portion 12c and a head cover 12d of resin mounted on the head portion 12c, as shown in FIGS. 2 and 5. The print head 12 is mounted inside the first and second side surfaces 11a and 11b of the chassis 11 to be rotatable about the support shafts 12a, as shown in FIG. 2. The plurality of heating elements 12e generating heat upon application of the voltage pulse are provided on the head portion 12c of the print head 12 in alignment with each other along the width direction (direction X) of the paper 50 at a prescribed interval, as shown in FIG. 8. The heating elements 12e are so formed that each heating element 12e forms a dot in printing.

The platen roller 13 (see FIG. 7) is rotatably arranged inside the first and second side surfaces 11a and 11b of the chassis 11. The feed roller 14 has a feed roller gear insertion portion 14a inserted into the feed roller gear 15, as shown in FIG. 6. This feed roller 14 is rotatably supported by a feed roller bearing (not shown) mounted on the chassis 11. Both ends of the press roller 16 are rotatably supported by a pair of press roller bearings 34 of resin, as shown in FIGS. 2 and 7. These press roller bearings 34 are mounted on a bearing support plate 35 of metal. The bearing support plate 35 is so arranged inside the first and second side surfaces 11a and 11b of the chassis 11 as to press the press roller 16 against the feed roller 14 (see FIG. 5) by urging force of a spring (not shown).

The paper feed roller 18 is so rotated by the stepping motor 24 as to feed the papers 50 stored in the paper feed cassette 60 mounted on the sublimatic printer 10 into the sublimatic printer 10 one by one, as shown in FIG. 2. The paper discharge roller 20 is so rotated by the stepping motor 24 as to discharge each printed paper 50 printed in the sublimatic printer 10 from the sublimatic printer 10.

A motor gear 36 is mounted on the shank of the stepping motor 24 mounted on the motor bracket 23, as shown in FIG. 6. The stepping motor 24 functions as a driving source for driving a gear portion 22a of the ink sheet take-up reel 22, the paper feed roller gear 19, the paper discharge roller gear 21 and the feed roller gear 15. On the other hand, the stepping motor 25 functions as a driving source for a pressing member (not shown) or the like pressing the upper surface of the print head 12 thereby pressing the print head 12 (see FIG. 5) against the platen roller 13 (see FIG. 5).

The ink sheet take-up reel 22 (see FIG. 6) is so formed as to engage with a take-up bobbin 70b rotatably arranged in a take-up portion 70a of the ink sheet cartridge 70 thereby taking up the ink sheet 71 on the take-up bobbin 70b, as shown in FIG. 5. The gear portion 22a of the ink sheet take-up reel 22 is so arranged as to engage with the swing gear 26 upon swinging thereof, as shown in FIG. 6.

The lower paper guide 17a is set in the vicinity of the feed roller 14 (see FIG. 5) and the press roller 16, as shown in FIGS. 2 and 5. The upper paper guide 17b is mounted on an upper portion of the lower paper guide 17a, as shown in FIG. 5. This upper paper guide 17b has a function of guiding each paper 50 to a printing portion (position where the head portion 12c of the print head 12 and the platen roller 13 are opposed to each other) through the lower surface thereof in paper feeding while guiding each paper 50 to a paper discharge path through the upper surface thereof in paper discharge.

The housing 32 includes lid members 32a and 32b and print buttons 32c, as shown in FIG. 4. The lid members 32a and 32b are so provided as to be rotatable about the lower ends thereof outward from the sublimatic printer 10, as shown in FIG. 4. The lid member 32a of the housing 32 is rendered openable/closable in order to mount the paper feed cassette 60 on the sublimatic printer 10, as shown in FIG. 4. When the paper feed cassette 60 is detached from the sublimatic printer 10, the lid member 32a is so closed as to inhibit dust etc. from entering the sublimatic printer 10. On the other hand, the lid member 32b of the housing 32 is rendered openable/closable in order to mount the ink sheet cartridge 70 on the sublimatic printer 10, as shown in FIG. 4. When the ink sheet cartridge 70 is not attached to/detached from the sublimatic printer 10, the lid member 32b is so closed as to inhibit dust etc. from entering the sublimatic printer 10. The print buttons 32c of the housing 32 are provided as pushbuttons pressed by the user for starting printing.

The ink sheet cartridge 70 is provided with a supply portion 70d rotatably storing a supply bobbin 70c wound with the ink sheet 71, as shown in FIG. 5. The ink sheet 71 is formed by successively connecting three color ink sheets including Y (yellow), M (magenta) and C (cyan) printing sheets and a transparent OP (overcoat) sheet for protecting the printed portion 50a of each printed paper 50. Printing sheet search identification portions (not shown) recognized by a sheet search sensor (not shown) in the start of printing are provided between the color printing sheets and the connected portions of the C (cyan) printing sheet and the OP (overcoat) sheet respectively.

The printing operation of the sublimatic printer 10 according to this embodiment is described with reference to FIGS. 1, 3 to 6 and 8 to 16.

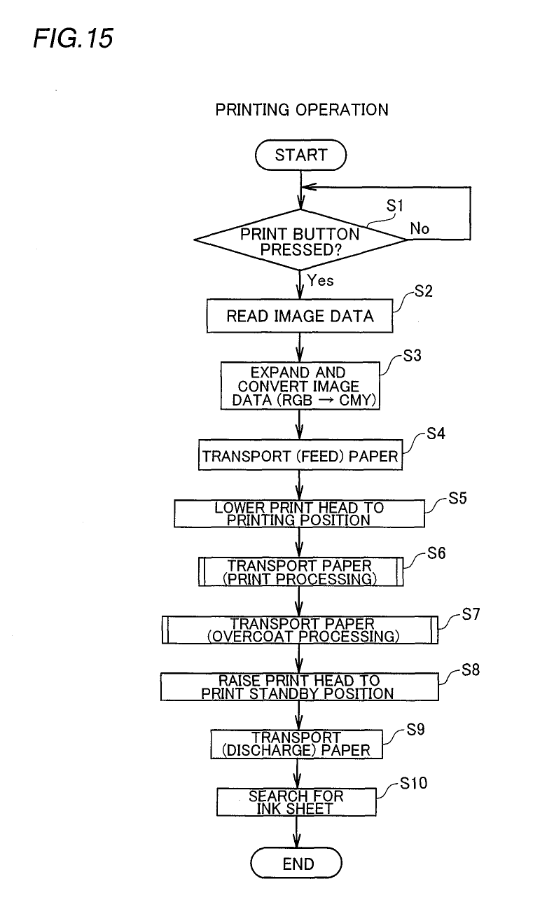

As shown in FIG. 15, the control portion 31a determines whether or not any print button 32c (see FIG. 4) has been pressed by the user at a step S1. If no print button 32c (see FIG. 4) has been pressed, the control portion 31a repeats this determination until any print button 32c (see FIG. 4) is pressed. If determining that the print button 32c (see FIG. 4) has been pressed at the step S1, the control portion 31a (see FIG. 3) reads image data at a step S2. Thereafter the control portion 31a (see FIG. 3) converts the read image data from the RGB data system to the CMY data system. The RGB data system is constituted of the three primary colors (R: red, G: green and B: blue) of light, while the CMY data system is constituted of the three primary colors (C: cyan, M: magenta and Y: yellow) of object color.

At a step S4, each paper 50 stored in the paper feed cassette 60 (see FIG. 1) is transported (fed) to the printing start position with the stepping motor 24 (see FIG. 1), as shown in FIG. 5. More specifically, the stepping motor 24 is so driven that the motor gear 36 mounted thereon rotates along arrow C3 and the feed roller gear 15 rotates along arrow C1 through the intermediate gears 27 and 28, as shown in FIG. 6. Following the rotation of the feed roller gear 15 along arrow C1, the paper feed roller gear 19 rotates along arrow C4 through the intermediate gears 29 and 30. Thus, the paper feed roller 18 also rotates along arrow C4 following the rotation of the paper feed roller gear 19 as shown in FIG. 5, thereby transporting the paper 50 in contact with the paper feed roller 18 in the paper feed direction (along arrow T1). At this time, the paper sensor 33a detects the front end 50d of the paper 50 in the paper feed direction, thereby recognizing correct paper feeding. Following the transportation of the paper 50 in the paper feed direction (along arrow T1), the paper sensor 33b detects the front end 50d of the paper 50. Thereafter the paper 50 is further transported by the paper feed roller 18 through the upper portion of the paper sensor 33b, guided by the lower paper guide 17a along the paper feed direction (along arrow T1), and transported to the printing start position shown in FIG. 13 by the feed roller 14 and the press roller 16. When the paper 50 is transported to the printing start position, the paper sensor 33a detects the rear end 50e of the paper 50 in the paper feed direction. At this time, the swingable swing gear 26 (see FIG. 6) is not in mesh with the gear 22a (see FIG. 6) of the take-up reel 22 (see FIG. 6), whereby the gear 22a (see FIG. 6) of the take-u reel 22 (see FIG. 6) remains unrotating. Thus, the ink sheet 71 wound on the take-up bobbin 70b (see FIG. 5) and the supply bobbin 70c (see FIG. 5) is not taken up in paper feeding.

At a step S5, the control portion 31a drives the stepping motor 25 (see FIG. 6) through the motor driver 31c (see FIG. 3). The stepping motor 25 (see FIG. 6) rotates the pressing member (not shown) from the state shown in FIG. 5, thereby rotating the head portion 12c of the print head 12 in the direction for pressing the platen roller 13, as shown in FIG. 13. Thus, the heating elements 12e (see FIG. 8) of the print head 12 press the platen roller 13 through the ink sheet 71 and the paper 50.

At a step S6, the image data converted to the CMY data system is successively printed with Y (yellow), M (magenta) and C (cyan) in this order. The print processing at the step S6 is now described in detail.

As shown in FIG. 6, the stepping motor 24 is so driven that the motor gear 36 mounted thereon rotates along arrow D3 and the feed roller gear 15 rotates along arrow D1 through the intermediate gears 27 and 28, as shown in FIG. 6. Thus, the feed roller 14 also rotates along arrow D1 following the rotation of the feed roller gear 15 along arrow D1, thereby transporting the paper 50 in a paper discharge direction (along arrow U1).

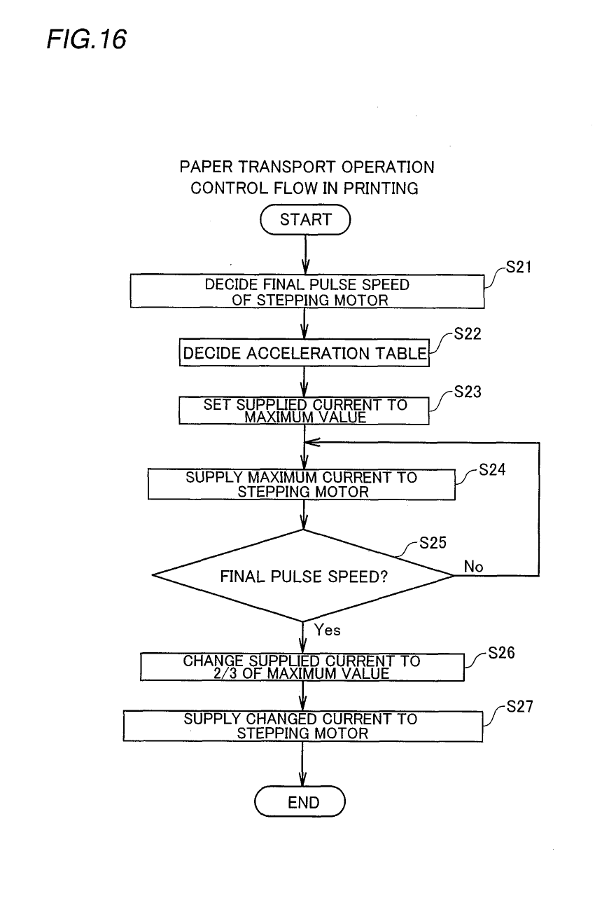

According to this embodiment, the control portion 31a makes transport control shown in FIG. 16 when starting transporting the paper 50 in the paper discharge direction (along arrow U1). At a step S21, the control portion 31a decides the printing speed Vp (see FIG. 11) in printing, in response to the printing mode such as the high definition printing mode or the standard printing mode. At a step S22, the control portion 31a decides one acceleration table 31d (see FIG. 10) for increasing the pulse speed of the stepping motor 24 from the relation between the length (feed margin) of the margins 50b (see FIG. 9) of the paper 50 and the printing speed Vp (see FIG. 11). Then, the control portion 31a sets the current I1 supplied to the stepping motor 24 to the maximum value at a step S23 as shown in FIG. 12, and supplies the current I1 through the motor driver 31c (see FIG. 3) at a step S24. At this time, the stepping motor 24 increases the pulse speed in an acceleration pattern (velocity curve) according to the acceleration table 31d (see FIG. 10) decided at the step S22. At a step S25, the control portion 31a determines whether or not the stepping motor 24 has reached the printing speed Vp (see FIG. 11), and successively increases the pulse speed of the stepping motor 24 according to the acceleration table 31d (see FIG. 10) decided at the step S22 if determining that the stepping motor 24 has not yet reached the printing speed Vp (see FIG. 11). If determining that the stepping motor 24 has reached the printing speed Vp (see FIG. 11) at the step S25, on the other hand, the control portion 31a switches the current I1 supplied to the stepping motor 24 to the current I2 of about ⅔ thereof and supplies the current I2 to the stepping motor 24 through the motor driver 31c (see FIG. 3) at a step S27, as shown in FIG. 12. Then, the control portion 31a prints the image data with Y (yellow) at the printing speed Vp (see FIG. 11) while holding the current I2, as shown in FIG. 12.

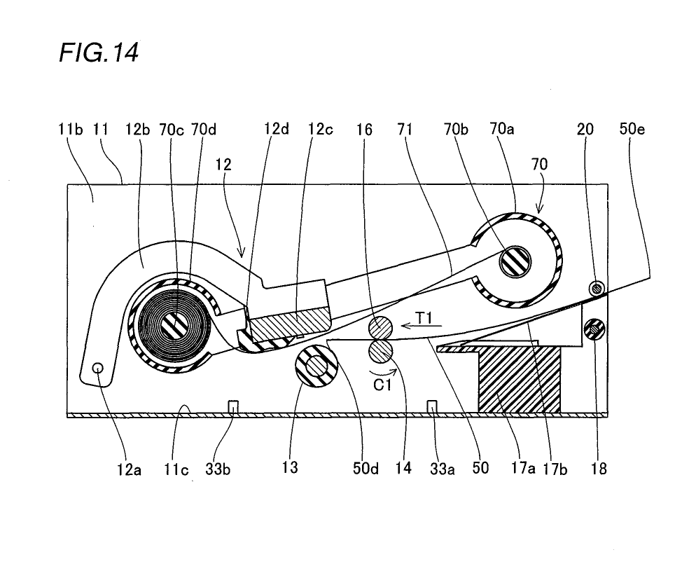

At this time, the paper 50 is transported in the paper discharge direction (along arrow U1 in FIG. 10) while the ink sheet 71 is taken up, so that the ink is printed (thermally transferred) from the Y (yellow) printing sheet (not shown) onto the paper 50 with the heating elements 12e of the print head 12, in correspondence to a concentration signal related to Y (yellow) of the image data preserved in the RAM 31g. When printed with the Y (yellow) printing sheet, the paper 50 is guided by the upper paper guide 17 to a position transportable with the paper discharge roller 20, as shown in FIG. 14.

The swingable swing gear 26 (see FIG. 6) swings in a direction (along arrow D2) for engaging with the gear portion 22a of the ink sheet take-up reel 22, to engage with the gear portion 22a of the ink sheet take-up reel 22. Thus, the gear portion 22a of the ink sheet take-up reel 22 (see FIG. 6) rotates along arrow D4 as shown in FIG. 13, thereby taking up the ink sheet 71 wound on the supply bobbin 70c on the take-up bobbin 70 along with transportation of the paper 50.

When the stepping motor 25 (see FIG. 6) upwardly rotates the pressing member (not shown) as a printing operation (print processing) subsequent to the aforementioned printing with Y (yellow) at the step S6, the head portion 12c of the print head 12 (see FIG. 5) rotates in a direction for separating from the platen roller 13 (see FIG. 5). Further, the sheet search sensor (not shown) recognizes the printing sheet search identification portion (not shown) provided on the head of the M (magenta) printing sheet (not shown). Thus, the sheet search sensor searches for the M (magenta) printing sheet. As shown in FIG. 6, the stepping motor 24 is so driven that the motor gear 36 mounted thereon rotates along arrow C3 and the feed roller gear 15 rotates along arrow C1 through the intermediate gears 27 and 28. Thus, the feed roller 14 and the press roller 16 transport the paper 50 to the printing start position again following the rotation of the feed roller 14 along arrow C1, as shown in FIG. 14.

According to this embodiment, the control portion 31a (see FIG. 3) performs control similar to the aforementioned operation of transporting the paper 50 for printing with Y (yellow) on the stepping motor 24 (see FIG. 3). In other words, the control portion 31a performs the control through the steps S21 to S27 shown in FIG. 16 when starting transporting the paper 50 in the paper discharge direction (along arrow U1 in FIG. 13). Thus, the ink is printed (thermally transferred) from the M (magenta) printing sheet (not shown) onto the paper 50 in correspondence to a concentration signal related to M (magenta) of the image data through an operation similar to the aforementioned one for printing with Y (yellow).

Thereafter the ink is printed (thermally transferred) from the C (cyan) printing sheet (not shown) onto the paper 50 in correspondence to a concentration signal related to C (cyan) of the image data through an operation similar to the aforementioned ones for Y (yellow) and M (magenta).

At a step S7, the ink is printed (thermally transferred) from the transparent OP (overcoat) sheet (not shown) onto the paper 50, in order to protect the surface of the printed paper 50.

At this time, the control portion 31a (see FIG. 3) performs the control at the steps S21 to S27 shown in FIG. 16 again when starting transporting the paper 50 in the paper discharge direction (along arrow U1 in FIG. 13), similarly to the aforementioned operation of transporting the paper 50 for printing with each color. Then, the control portion 31a performs an operation similar to the aforementioned one for printing the paper 50 with each color, thereby printing the ink from the OP (overcoat) sheet (not shown) onto the paper 50 and terminating the print processing on the paper 50 shown at the steps S6 and S7.

At a step S8, the control portion 31a raises the print head 12 to a print standby position with pressing means (not shown) by driving the stepping motor 25.

At a step S9 shown in FIG. 15, the printed paper 50 is guided by the upper paper guide 17b and discharged by the paper discharge roller 20, as shown in FIG. 14. At this time, the stepping motor 24 (see FIG. 6) and the gears perform operations similar to those for transporting the paper 50 in the paper discharge direction (along arrow U1 in FIG. 13) in printing.

Then, the Y (yellow) printing sheet (not shown) is searched for in preparation for subsequent printing at a step S10. In other words, the ink sheet 71 is taken up until the sheet search sensor (not shown) recognizes the corresponding printing sheet search identification portion (not shown). The ink sheet 71 is taken up through an operation similar to the aforementioned one for printing the paper 50. The printing operation is terminated when the Y (yellow) printing sheet (not shown) is completely searched for, and the control portion 31a (see FIG. 3) stops the printing operation and waits until the user presses any print button 32c (see FIG. 4) again.

According to this embodiment, as hereinabove described, the sublimatic printer 10 is so formed as to comprise the control portion 31a supplying the current I1 to the stepping motor 24 in the acceleration period Tacc of the stepping motor 24 for bringing the paper 50 to the printing speed Vp from the start of transportation while switching to the current I2 smaller than the current I1 in synchronization with arrival of the paper 50 at the printing speed Vp for supplying the current I2 to the stepping motor 24 for making control of reducing the amount of energy (current) supplied to the stepping motor 24 transporting the paper 50 at the printing speed Vp from the current I1 to the current I2 in synchronization with the time for starting printing when the paper 50 reaches the printing speed Vp and the print head 12 generates heat to consume power, whereby power consumption in the overall sublimatic printer 10 in printing can be reduced dissimilarly to a case of making control of not changing the amount of energy (current) supplied to the stepping motor 24 in the acceleration period Tacc of the stepping motor 24 in the start of paper transportation and the amount of energy (current) supplied to the stepping motor 24 for driving the same at the printing speed Vp in printing or making control of not reducing the amount of energy (current) in a prescribed period in printing after a lapse of the acceleration period Tacc.

According to this embodiment, the sublimatic printer 10 is so formed that the current I1 supplied to the stepping motor 24 in the acceleration period Tacc of the stepping motor 24 is substantially the maximum value in the drivable range of the stepping motor 24 so that the stepping motor 24 can start transporting the paper 50 with the maximum acceleration, whereby the acceleration period Tacc for bringing the paper 50 to the printing speed Vp can be minimized. Therefore, the total printing time including the time for paper transportation can be further reduced.

According to this embodiment, the sublimatic printer 10 is so formed that the current I2 supplied to the stepping motor 24 at the printing speed Vp is not more than ⅔ of the maximum current I1 supplied to the stepping motor 24 in the acceleration period Tacc, whereby power consumption in the stepping motor 24 can be effectively reduced while maintaining driving torque allowing transportation of the paper 50 at the printing speed Vp in printing.

According to this embodiment, the sublimatic printer 10 is so formed as to comprise the ROM 31f storing the acceleration table 31d defining the pulse speed with respect to the driving times (control steps) for the stepping motor 24 so that the control portion 31a drives the stepping motor 24 on the basis of the acceleration table 31d in the acceleration period Tacc of the stepping motor 24, whereby the control portion 31a can make control of smoothly transporting the paper 50 when the stepping motor 24 starts acceleration (starts transporting the paper 50) and when the stepping motor 24 ends the acceleration (upon arrival of the paper 50 at the printing speed Vp) respectively, thereby transporting the paper 50 in the optimum state without steeply changing the transport speed for the paper 50, as shown in FIG. 11.

According to this embodiment, the ROM 31f is so formed as to store the plurality of acceleration tables 31d in response to the printing quality (the high definition printing mode or the standard printing mode) of the image data, whereby the control portion 31a can easily transport the paper 50 at a speed responsive to the printing quality of the image data by selecting the optimum acceleration table 31d.

According to this embodiment, the paper 50 includes the printed portion 50a printed with the image data and the margins 50b not printed with the image data and the control portion 31a is so formed as to make control as the acceleration period Tacc of the stepping motor 24 when transporting the margins 50b of the paper 50 so that the transport speed for the paper 50 can be increased through the margins 50b not directly relevant to printing, whereby the total printing time including the time for paper transportation can be further reduced.

According to this embodiment, the driving source is formed by the stepping motor 24 whose rotation angle is controllable with the pulse number so that the rotational speed (pulse speed) of the driving source can be controlled by controlling the pulse number, whereby the transport speed for the paper 50 including that in the acceleration period Tacc can be reliably controlled and the amount of energy (current) supplied to the driving source can be switched at reliable timing after the arrival at the printing speed Vp.

According to this embodiment, the sublimatic printer 10 is so formed that both of the first amount of energy and the second amount of energy supplied to the stepping motor 24 are currents, whereby a control circuit for carrying out a constant voltage control system controlling currents supplied to the stepping motor 24 can be more easily designed on an electric circuit as compared with a case of designing a control circuit for carrying out a constant current control system controlling voltages supplied to the stepping motor 24.

Although the present invention has been described and illustrated in detail, it is clearly understood that the same is by way of illustration and example only and is not to be taken by way of limitation, the spirit and scope of the present invention being limited only by the terms of the appended claims.

For example, while the aforementioned embodiment is applied to the sublimatic printer 10 employed as an exemplary image generating apparatus comprising the feed roller 14 transporting the papers 50 printable with image data and the stepping motor 24 for driving the press roller 16, the present invention is not restricted to this but is also applicable to another image generating apparatus other than the sublimatic printer, so far as the image generating apparatus comprises a stepping motor for driving transport means transporting papers printable with image data.

While the current I2 supplied to the stepping motor 24 at the printing speed Vp is set to ⅔ of the maximum current I1 supplied to the stepping motor 24 in the acceleration period Tacc in the aforementioned embodiment, the present invention is not restricted to this but the current I2 may be set to a level of less than ⅔ of the current I1 in the range for attaining driving torque allowing transportation of the paper 50 at the printing speed Vp in printing, so that power consumption in printing can be further reduced.

While the control portion 31a controls the currents supplied to the stepping motor 24 in the constant voltage control system in the aforementioned embodiment, the present invention is not restricted to this but the control portion 31a may alternatively control voltages supplied to the stepping motor 24 in a constant current control system. Also according to this modified structure, the control portion 31a can control the stepping motor 24 in the constant current control system controlling voltages supplied thereto similarly to the above, thereby reducing power consumption in the overall sublimatic printer 10 in printing.

While the control portion 31a performs the control of increasing the transport speed for the paper 50 up to the printing speed Vp while setting the current I1 supplied to the stepping motor 24 to the maximum level when transporting the margins 50b of the paper 50 in printing in the aforementioned embodiment, the present invention is not restricted to this but the control portion 31a may alternatively perform the control of increasing the transport speed for the paper 50 up to the printing speed Vp while setting the current I1 supplied to the stepping motor 24 to the maximum level also when transporting a portion of the paper 50 not printed on the printed portion 50a in response to the printed image size (region where image data is present in practice). According to this modified structure, the control portion 31a can increase the transport speed for the paper 50 also when transporting the same to the printing start position, thereby further reducing the transport time for the paper 50.

While the control portion 31a performs the control of increasing the transport speed for the margins 50b of the paper 50 while setting the current I1 supplied to the stepping motor 24 to the maximum level immediately before the print processing for transferring (printing) the inks from the color printing sheets and the overcoat sheet of the ink sheet 71 to the paper 50 while pressing the print head 12 in the printing operation in the aforementioned embodiment, the present invention is not restricted to this but the control portion 31a may alternatively perform control of increasing the transport speed for the paper 50 to a constant value while setting the current I1 supplied to the stepping motor 24 to the maximum level when starting transporting the paper 50 also when feeding the paper 50 from the paper feed cassette 60 to a printer body or transporting the paper 50 to the printing start position for printing a subsequent color (transition to M (magenta) after printing with Y (yellow) or transition to (cyan) after printing with M (magenta), for example). According to this modified structure, the control portion 31a can increase the transport speed for the paper 50 also when feeding the paper 50 from the paper feed cassette 60 into the printer body, thereby further reducing the transport time for the paper 50.

What is claimed is:

1. An image generating apparatus comprising:
a driving source for driving transport means transporting a paper printable with image data; and
a control portion supplying a first amount of energy to said driving source in an acceleration period of said driving source for bringing said paper to a constant speed from the start of transportation while switching to a second amount of energy smaller than said first amount of energy in synchronization with arrival of said paper at said constant speed for supplying said second amount of energy to said driving source.

2. The image generating apparatus according to claim 1, wherein
said first amount of energy supplied to said driving source in said acceleration period of said driving source is substantially the maximum amount of energy in the drivable range of said driving source.

3. The image generating apparatus according to claim 1, wherein
said amount of energy supplied to said driving source at said constant speed is not more than ⅔ of the maximum amount of energy supplied to said driving source in said acceleration period.

4. The image generating apparatus according to claim 1, further comprising a storage portion storing an acceleration table defining a rotational speed with respect to a driving time of said driving source, wherein
said control portion drives said driving source on the basis of said acceleration table in said acceleration period of said driving source.

5. The image generating apparatus according to claim 4, wherein
said storage portion stores a plurality of said acceleration tables in response to the printing quality of said image data.

6. The image generating apparatus according to claim 1, wherein
said paper includes a printed portion printed with said image data and a margin not printed with said image data, and
said control portion makes control as said acceleration period of said driving source at least when transporting said margin of said paper.

7. The image generating apparatus according to claim 6, wherein
said control portion makes said control as said acceleration period of said driving source not only when transporting said margin of said paper but also when transporting a position of said printed portion printed with said image data.

8. The image generating apparatus according to claim 1, further comprising an apparatus body detachably mounted with a paper feed cassette storing said paper, wherein
said control portion makes control as said acceleration period of said driving source when transporting said paper from said paper feed cassette to said apparatus body.

9. The image generating apparatus according to claim 1, wherein
said driving source is a stepping motor whose rotation angle is controllable with a pulse number.

10. The image generating apparatus according to claim 1, wherein
both of said first amount of energy and said second amount of energy supplied to said driving source are currents.

11. The image generating apparatus according to claim 1, wherein
both of said first amount of energy and said second amount of energy supplied to said driving source are voltages.

12. An image generating apparatus comprising:
a driving source for driving transport means transporting a paper printable with image data; and
a control portion transporting at least a margin of said paper and supplying a first amount of energy substantially corresponding to the maximum amount of energy in the drivable range of said driving source to said driving source in an acceleration period of said driving source for bringing said paper to a constant speed from the start of transportation while switching to a second amount of energy, smaller than said first amount of energy, not more than ⅔ of said first amount of energy in synchronization with arrival of said paper at said constant speed for supplying said second amount of energy to said driving source, wherein
said paper includes a printed portion printed with said image data and said margin not printed with said image data, and
said driving source is a stepping motor whose rotation angle is controllable with a pulse number.

13. The image generating apparatus according to claim 12, further comprising a storage portion storing an acceleration table defining a rotational speed with respect to a driving time of said driving source, wherein
said control portion drives said driving source on the basis of said acceleration table in said acceleration period of said driving source.

14. The image generating apparatus according to claim 13, wherein
said storage portion stores a plurality of said acceleration tables in response to the printing quality of said image data.

15. The image generating apparatus according to claim 12, wherein
said control portion makes said control as said acceleration period of said driving source not only when transporting said margin of said paper but also when transporting a position of said printed portion printed with said image data.

16. The image generating apparatus according to claim 12, further comprising an apparatus body detachably mounted with a paper feed cassette storing said paper, wherein
said control portion makes control as said acceleration period of said driving source when transporting said paper from said paper feed cassette to said apparatus body.

17. The image generating apparatus according to claim 12, wherein
both of said first amount of energy and said second amount of energy supplied to said driving source are currents.

18. The image generating apparatus according to claim 12, wherein
both of said first amount of energy and said second amount of energy supplied to said driving source are voltages.
